(19) United States
(12) Patent Application Publication
(10) Pub. No.: US 2026/0316331 A1
(43) Pub. Date: Oct. 15, 2026

(54) METHOD FOR MANUFACTURING A PREFABRICATED ELEMENT FOR A DWELLING

(71) Applicant: CUBIK-HOME, Chaleins (FR)

(72) Inventor: David DAMICHEY, Magny-Cours (FR)

(73) Assignee: CUBIK-HOME, Chaleins (FR)

(21) Appl. No.: 19/105,467

(22) PCT Filed: Aug. 18, 2023
(86) PCT No.: PCT/FR2023/051281

§ 371 Date: Feb. 21, 2025

(30) Foreign Application Priority Data
Aug. 23, 2022 (FR) 22/08468

(51) Int. Cl. B28B 19/00; E04B 2/00; E04C 2/288

(52) U.S. Cl. CPC B28B 19/003; E04C 2/288; E04C 2/46

(57) ABSTRACT

The present invention relates to a method for manufacturing a prefabricated element, involving the provision of a main formwork comprising a bottom wall (3) and a peripheral frame (4) delimiting an internal space, the fitting of at least one thermal insulation element (7) in the internal space of the main formwork such that the at least one thermal insulation element (7) rests on the bottom wall (3), the pouring of a composite construction material into the internal space of the main formwork so as to cover the at least one thermal insulation element (7), the hardening of the composite construction material so as to form a load-bearing structure comprising longitudinal and transverse rims formed by the hardening of the composite construction material, the at least one thermal insulation element (7) being secured to and made inseparable from the load-bearing structure during the hardening of the composite construction material, and the removal of the main formwork (2) surrounding the prefabricated element obtained.

### TECHNICAL FIELD

The present invention concerns generally a method for manufacturing a prefabricated element for the production of an individual, industrial or commercial dwelling unit, and more particularly a method for manufacturing a prefabricated element including at least one thermally insulating element.

### STATE OF THE ART

In the field of construction, it is well known to manufacture uniform dwelling units obtained from prefabricated elements. This uniformity is one of the conditions of standardization, therefore of reduction of manufacturing costs and it is maximum when a construction can be reduced to an assembly of identical or similar prefabricated elements, integrating the greatest possible number of equipment.

The search for a decreasing in manufacturing costs, a guarantee of quality in order to reduce harmful effects on the environment and, above all, a permanence of these qualities across all the products of a construction company, as well as better working conditions for workers assigned to the construction of buildings, requires the use of prefabricated elements.

In order to improve the thermal insulation of a prefabricated element, it is known to fasten, in the factory or on the construction site of the dwelling unit, thermal insulation elements in cells formed in the prefabricated element. This solution, although functional, is generally time consuming and involves meticulous implementation in order to maximize the efficiency of the thermal insulation of the dwelling unit.

### SUMMARY OF THE INVENTION

The present invention aims to remedy these drawbacks.

The technical problem underlying the invention consists in particular in providing a method for manufacturing a prefabricated element allowing an easy and rapid integration of at least one thermal insulation element, while being simple, economical and easily standardizable.

For this purpose, the present invention concerns a method for manufacturing a prefabricated element for a dwelling unit, the manufacturing method including the following steps of:
providing a main formwork comprising a bottom wall and a peripheral frame, the bottom wall and the peripheral frame delimiting an internal space,
placing at least one thermal insulation element, such as a thermal insulation panel for example, in the internal space of the main formwork such that the at least one thermal insulation element rests on the bottom wall, the at least one thermal insulation element and the main formwork being configured so as to delimit at least in part a longitudinal recess extending along each internal longitudinal face of the main formwork, and at least in part a transverse recess extending along each internal transverse face of the main formwork,
pouring a composite building material, which is hardenable, inside the internal space of the main formwork so as to at least partially cover the at least one thermal insulation element and to at least partially fill each of the longitudinal and transverse recesses,
hardening the composite building material so as to form a load-bearing structure comprising a main wall provided with a first face facing the at least one thermal insulation element and a second face opposite the first face, the load-bearing structure further comprising two longitudinal edges extending along two opposite longitudinal edges of the main wall and projecting from the first face of the main wall and two transverse edges extending along two opposite transverse edges of the main wall and projecting from the first face of the main wall, the longitudinal and transverse edges also being formed by the hardening of the composite building material poured into each of the longitudinal and transverse recesses, the at least one thermal insulation element being secured and made inseparable from the load-bearing structure during the hardening of the composite building material,
removing the main formwork surrounding the prefabricated element thus obtained.

The manufacturing method according to the present invention makes it possible to easily integrate at least one thermal insulation element into the prefabricated element, while ensuring a robust and reliable fastening of such a thermal insulation element to the load-bearing structure.

Furthermore, the prefabricated element obtained by the implementation of the manufacturing method according to the present invention incorporates longitudinal and transverse edges which provide an increased mechanical resistance to the prefabricated element, this by a local thickening of the thickness of the load-bearing structure.

The manufacturing method according to the invention may further have one or several of the following characteristics, taken alone or in combination.

According to one embodiment of the invention, the first face of the main wall corresponds to an internal face of the load-bearing structure, that is to say a face intended to face the inside of the dwelling unit.

According to one embodiment of the invention, the main wall of the load-bearing structure has a substantially constant thickness.

According to one embodiment of the invention, the longitudinal and transverse edges extend substantially perpendicular to the main wall of the load-bearing structure.

According to one embodiment of the invention, the peripheral frame of the main formwork is substantially rectangular.

According to one embodiment of the invention, at least one of the longitudinal and/or transverse recesses has a depth less than or equal to the maximum thickness of the at least one thermal insulation element.

According to one embodiment of the invention, the load-bearing structure has a generally rectangular shape.

According to one embodiment of the invention, the thermal insulation element has a generally rectangular shape.

According to one embodiment of the invention, the at least one thermal insulation element is a foam block that is preformed or machined. The foam block may be a semi-rigid foam block, and for example an expanded foam block.

According to one embodiment of the invention, the at least one thermal insulation element is made of polystyrene, polyurethane, wood fiber, natural fiber or mineral wool for example.

According to one embodiment of the invention, the thermal insulation element includes a main area which is quadrangular in shape, at least one of the upper ridges of the main area being rounded or including a cutaway, for example such that the internal face of each longitudinal edge has a cutaway or is rounded and such that the internal face of each transverse edge has a cutaway or is rounded.

An upper ridge means a ridge extending around the periphery of the main area and which is located in the upper part of the thermal insulation element when the latter rests on the bottom wall of the main formwork.

According to one embodiment of the invention, each upper ridge of the main area is rounded or includes a cutaway.

Such roundings and/or cutaways are intended to facilitate and improve the flowability of the composite building material during the manufacture and also to promote the diffusion of mechanical forces in the obtained prefabricated element or in contiguous prefabricated elements. Thus, such a configuration of the main area confers an increased mechanical strength to the obtained prefabricated element and to the dwelling unit obtained by the assembly of such prefabricated elements.

According to one embodiment of the invention, the thermal insulation element further includes a thinned peripheral area which is contiguous to the main area and which extends at least partly around the main area, the thinned peripheral area being configured to form at least partly at least one of the longitudinal and transverse recesses.

According to one embodiment of the invention, the composite building material is manufactured from crushed materials, natural materials, or a combination of crushed and natural materials, which are agglomerated by a binder, such as high-performance fiber concrete or the like for example. High-performance concrete is understood to mean concrete having a minimum mechanical resistance in compression usually measured on standardized cylindrical test pieces, in the range of 50 MPa.

According to one embodiment of the invention, the at least one thermal insulation element also includes at least one longitudinal groove which is configured to be filled by the composite building material during the pouring step and/or at least one transverse groove which is configured to be filled by the composite building material during the pouring step, such that the load-bearing structure includes at least one longitudinal reinforcing rib and/or at least one transverse reinforcing rib.

According to one embodiment of the invention, the placing step comprises placing several thermal insulation elements in the internal space of the main formwork, two adjacent thermal insulation elements being configured to delimit an intermediate recess configured to be filled by the composite building material during the pouring step such that the load-bearing structure includes at least one intermediate reinforcing rib located between two adjacent thermal insulation elements.

According to one embodiment of the invention, the upper ridges of the main area of each thermal insulation element are configured such that each lateral face of the at least one intermediate reinforcing rib has a favorable cutaway or is rounded.

According to one embodiment of the invention, the manufacturing method further includes the following step, which is prior to the pouring step:
placing at least one fastening insert, such as a wooden batten for example, in the internal space of the main formwork such that the at least one fastening insert rests on the bottom wall and is disposed between and in contact with two adjacent thermal insulation elements, the at least one fastening insert being secured and made inseparable from the load-bearing structure during the hardening of the composite building material and being configured to receive inner cladding supports.

According to one embodiment of the invention, the placing step comprises placing, at regular intervals, a plurality of fastening inserts in the internal space of the main formwork. Advantageously, the spacing distance between two adjacent fastening inserts is defined so as to correspond to the spacing between two finishing plates, such as plasterboard for example, affixed to the inner face of the prefabricated element in order to carry out the finishing and the cladding of the walls of the dwelling unit. Advantageously, each fastening insert makes it possible to easily secure the finishing plates on the inner face by means of plaster screws for example.

According to one embodiment of the invention, the manufacturing method further includes the following step, which is prior to the pouring step:
placing at least one insert to be demolded in the internal space of the main formwork such that the at least one insert to be demolded rests on the bottom wall and is adjoined to one of the sides of the peripheral frame.

The presence of such an insert to be demolded makes it possible to obtain a longitudinal or transverse edge, at said insert to be demolded, having a thickness less than the maximum thickness of the adjacent thermal insulation element, and therefore located set back from said longitudinal or transverse edge.

According to one embodiment of the invention, the manufacturing method further includes the following step, subsequent to the hardening step:
removing at least one insert to be demolded in order to define a shoulder area.

The presence of the shoulder area makes it possible to form, when assembling two adjacent prefabricated elements, a junction which does not reveal the load-bearing structures of said prefabricated elements from inside the dwelling unit.

According to one embodiment of the invention, the manufacturing method also includes the following step, prior to the step of placing the at least one thermal insulation element:
placing at least one secondary formwork, provided with an internal frame, in the internal space of the main formwork such that said internal frame rests on the bottom wall;

and wherein the at least one thermal insulation element and/or the at least one secondary formwork are configured so as to delimit a secondary recess extending around the secondary formwork and intended to be filled, at least in part, with composite building material during the pouring step.

Advantageously, the secondary recess allows, after the pouring and hardening steps, the formation of internal edges delimiting a generally rectangular opening where a leaf, such as a window or a door for example, can possibly be fastened.

According to one embodiment of the invention, the transverse or longitudinal edges of the load-bearing structure respectively include first and second assembly elements configured to allow the assembly of two adjacent prefabricated elements together.

According to one embodiment of the invention, each first assembly element is a threaded rod and each second assembly element is an assembly orifice configured to cooperate with a first assembly element of an adjacent prefabricated element when assembling two adjacent prefabricated elements.

According to another embodiment of the invention, the first and second assembly elements could be formed by screw/nut systems or any other assembly device intended to secure two separate parts for example.

According to one embodiment of the invention, the first assembly elements are positioned inside the internal space before the pouring step, and for example in longitudinal and/or transverse recesses.

### BRIEF DESCRIPTION OF THE FIGURES

The present invention will be better understood with the aid of the description which follows with reference to the appended figures, in which identical reference signs correspond to structurally and/or functionally identical or similar elements.

FIG. 1 is a front perspective view of a thermal insulation element used in the implementation of the manufacturing method according to the present invention;

FIG. 2 is a top perspective view of a main formwork used in the implementation of the manufacturing method according to the present invention;

FIG. 3 is a perspective view of the main formwork of FIG. 2 equipped with two secondary formworks;

FIG. 4 is a top perspective view of the main formwork of FIG. 2 after placing several thermal insulation elements;

FIG. 5 is a top perspective view of the main formwork of FIG. 2 after pouring a composite building material into the main formwork;

FIG. 6 is a side perspective view of a prefabricated element resulting from the implementation of the manufacturing method according to a first embodiment of the invention;

FIG. 7 is a side perspective view of a prefabricated element resulting from the implementation of the manufacturing method according to a second embodiment of the invention;

FIG. 8 is a longitudinal sectional view of a prefabricated element resulting from the implementation of the manufacturing method according to the invention;

FIG. 9 is a longitudinal sectional view of an assembly of two prefabricated elements;

FIG. 10 is a perspective view of a dwelling unit made from prefabricated elements obtained by the implementation of the manufacturing method of the invention;

FIG. 11 is a schematic view of the first and second assembly elements of two prefabricated elements.

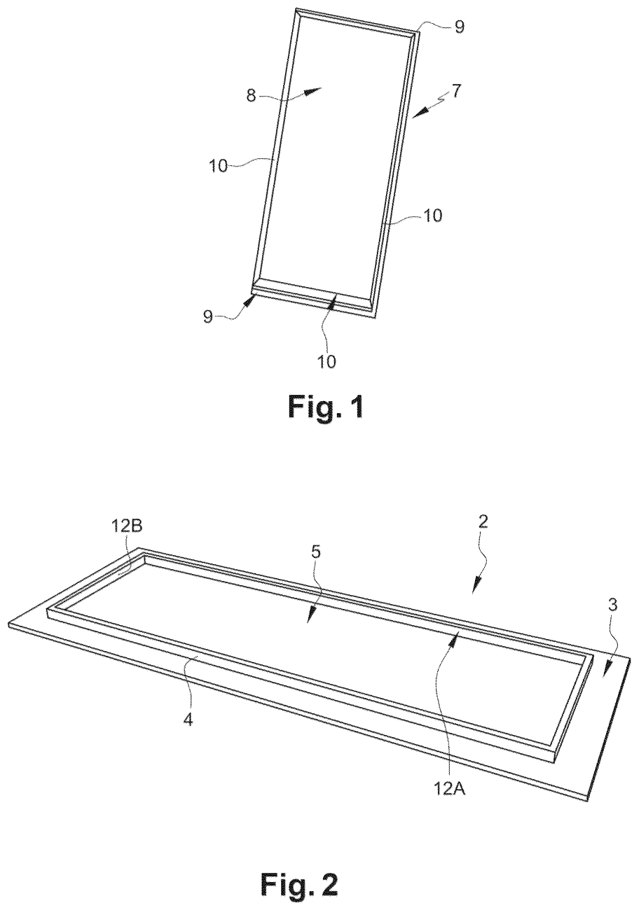

### DETAILED DESCRIPTION

The present invention concerns a method for manufacturing a prefabricated element 1 for the production of a dwelling unit.

The manufacturing method includes in particular (see FIG. 2) the provision of a main formwork 2 which comprises a bottom wall 3 and a peripheral frame 4, and which delimits an internal space 5.

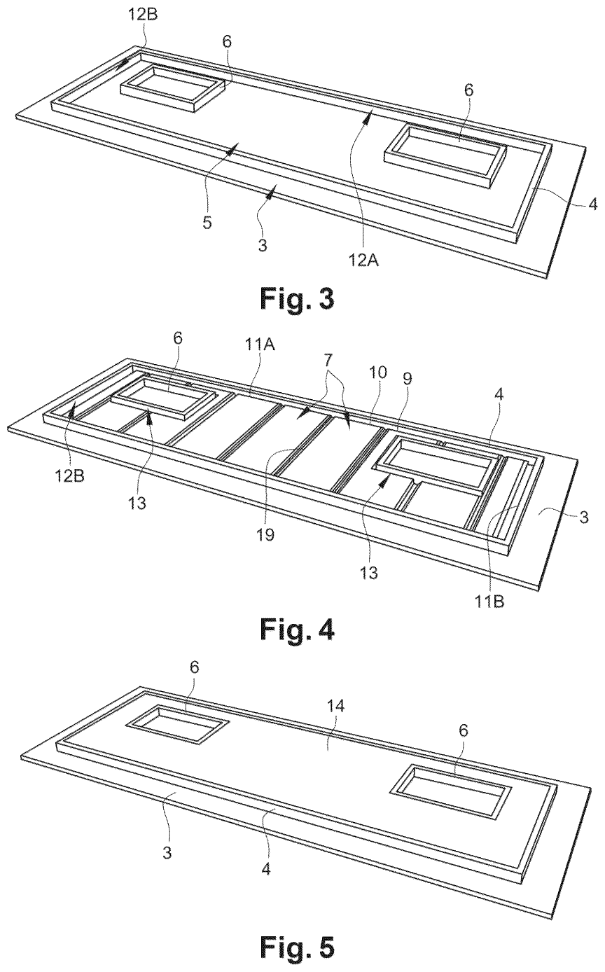

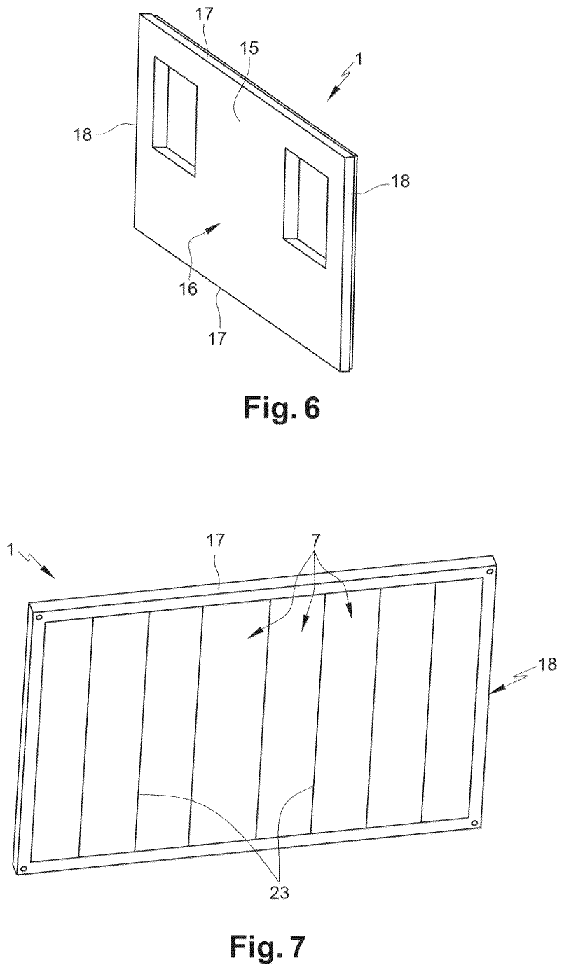

To the extent that the prefabricated element 1 to be manufactured may include one or several openings, intended for example to receive leafs such as windows, doors or French windows, the manufacturing method further includes (see FIG. 3) the placing of one or several secondary formworks, each provided with an internal frame 6, in the internal space 5 of the main formwork 2 such that each internal frame 6 rests on the bottom wall 3. The internal frame 6 is in particular located at a distance from the peripheral frame 4 when the production of an opening is desired.

The manufacturing method further includes (see FIG. 4) the placing of several thermal insulation elements 7 in the internal space 5 of the main formwork 2 such that each thermal insulation element 7 rests on the bottom wall. The thermal insulation elements 7 are positioned so as to partially occupy the internal space 5.

As shown more particularly in FIG. 4, each thermal insulation element 7 is formed by a thermal insulation panel which can for example be preformed or machined. Each thermal insulation element 7 can in particular be made of semi-rigid foam, for example expanded foam.

Each thermal insulation element 7 includes a main area 8, of generally rectangular shape, and a thinned peripheral area 9 which extends partially or completely around the main area 8 and which is contiguous to the main area 8. Advantageously, the upper ridges 10 of the main area 8 are rounded or each include a cutaway.

Advantageously, the thinned peripheral area 9 of each of the thermal insulation elements 7 and the main formwork 2 are configured so as to delimit a longitudinal recess 11A along each internal longitudinal face 12A of the peripheral frame 4, and to delimit a transverse recess 11B along each internal transverse face 12B. Each of the longitudinal 11A and transverse 11B recesses have a depth less than or equal to the maximum thickness of the thermal insulation elements 7. The thermal insulation elements 7 and the secondary formwork are configured so as to also delimit a secondary recess 13 extending around each of the internal frames 6.

The manufacturing method further includes (see FIG. 5) pouring a composite building material 14, which is hardenable, inside the internal space 5 of the main formwork 2 so as to completely or partially cover the thermal insulation elements 7 and to fill each of the longitudinal 11A and transverse 11B recesses and the secondary recesses 13. Advantageously, the composite building material 14 is manufactured from crushed materials, natural materials, or a combination of crushed and natural materials, which are agglomerated by a binder, such as high-performance concrete for example.

The manufacturing method also includes hardening the composite building material 14 so as to form a load-bearing structure 15 comprising a main wall 16 provided with a first face facing the thermal insulation elements 7 and a second face opposite the first face. The load-bearing structure 15 further comprises longitudinal edges 17 extending along two opposite longitudinal edges of the main wall 16 and projecting from the first face of the main wall 16, and transverse edges 18 extending along two opposite transverse edges of the main wall 16 and projecting from the first face of the main wall 16, the longitudinal 17 and transverse 18 edges being formed by the hardening of the composite building material 14 poured into each of the longitudinal 11A and transverse 11B recesses.

Advantageously, the thermal insulation elements 7 are secured and made inseparable from the load-bearing structure 15 during the hardening of the composite building material 14.

The roundings and/or the cutaways of the upper ridges of each of the thermal insulation elements 7 are intended to facilitate and improve the flowability of the composite building material 14 during the pouring step, and also to promote the diffusion of mechanical forces in the obtained prefabricated element 1 or in contiguous prefabricated elements. Thus, such a configuration of the upper ridges 10 of the main area 8 confers an increased mechanical resistance to the obtained prefabricated element 1 and to the dwelling unit obtained by the assembly of such prefabricated elements 1.

When placing the main formwork 2 and the thermal insulation elements 7, two adjacent thermal insulation elements 7 are advantageously configured to delimit an intermediate recess 19 configured to be filled by the composite building material 14 during the pouring such that the load-bearing structure 15 includes intermediate reinforcing ribs 20 located between two adjacent thermal insulation elements 7. Advantageously, the upper ridges 10 of the main area 8 of each thermal insulation element 7 are configured such that each lateral face of each intermediate reinforcing rib 20 advantageously has a cutaway or is rounded.

Advantageously, the secondary recesses 13 make it possible, after the pouring and hardening steps, to form internal edges delimiting an opening in which a leaf, such as a window or a door for example, can be fastened.

As shown more particularly in FIG. 11, the transverse 18 or longitudinal 17 edges of the load-bearing structure 15 respectively include first assembly elements 21 and second assembly elements 22 configured to allow the assembly of two prefabricated elements 1 adjacent to each other. The main wall 16 may also include assembly elements configured to allow the assembly of two prefabricated elements 1 adjacent to each other.

In the exemplary embodiment presented in FIG. 11, each first assembly element 21 is a threaded rod and each second assembly element 22 is an assembly orifice configured to cooperate with the first assembly element 21 of an adjacent prefabricated element 1 during the assembly of two adjacent prefabricated elements 1.

Advantageously, the first assembly elements 21 are positioned inside the internal space before the pouring step, and for example in longitudinal or transverse recesses, such that they can be made inseparable from the load-bearing structure during the hardening step.

The manufacturing method further includes the removal of the main formwork 2 surrounding the prefabricated element 1 thus obtained.

Incidentally, the prefabricated element 1 may include ducts (not represented) for the various networks, such as electricity, water, gas, etc., disposed in the thermal insulation panels 7 and/or between the main wall 16 and an inner cladding fastened to the latter.

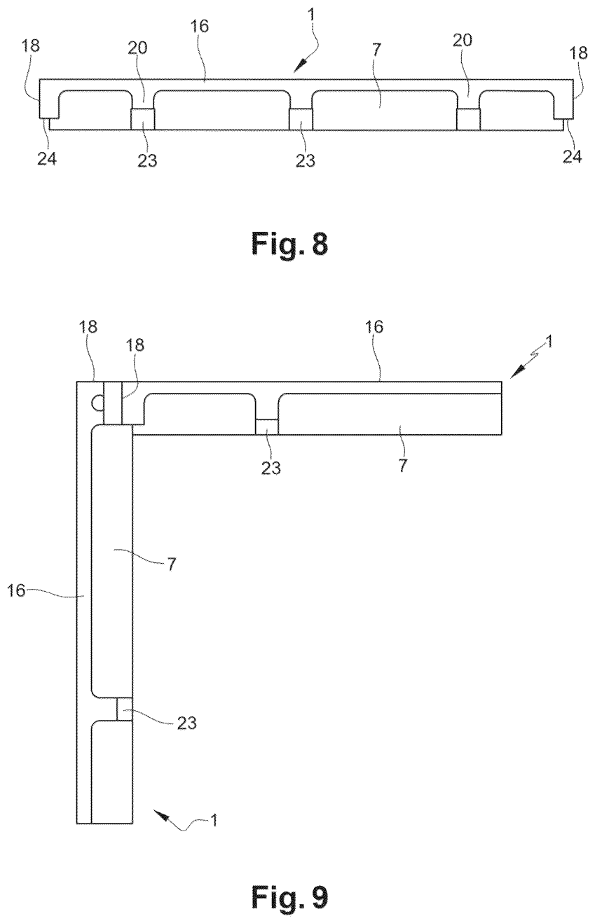

FIGS. 7 and 8 represent a prefabricated element 1 obtained by the implementation of a manufacturing method according to a second embodiment of the invention which differs from the first embodiment in particular in that it does not require the presence of a secondary formwork.

The manufacturing method according to the second embodiment of the invention includes in particular the following steps:
providing a main formwork 2 comprising a bottom wall 3 and a peripheral frame 4, the main formwork 2 delimiting an internal space 5,
placing the thermal insulation elements 7 in the internal space 5 of the main formwork 2 such that the thermal insulation elements 7 rest on the bottom wall 3 and delimit with the main formwork 2 a longitudinal recess 11A along each internal longitudinal face 12A of the main formwork 2 and a transverse recess 11B along each internal transverse face 12B of the main formwork 2;
placing a plurality of fastening inserts 23, such as wooden battens for example, in the internal space 5 of the main formwork 2 such that the fastening inserts 23 rest on the bottom wall 3 and are each disposed between and in contact with two respective adjacent thermal insulation elements 7;
placing inserts to be demolded in the internal space 5 of the main formwork 2 such that each insert to be demolded rests on the bottom wall 3 and is adjoined to a respective lateral side of the peripheral frame 4;
pouring a composite building material 14, which is hardenable, inside the internal space 5 of the main formwork 2 so as to partially or completely cover the thermal insulation elements 7, the inserts to be demolded and the fastening inserts, and to fill each of the longitudinal 11A and transverse 11B recesses,
hardening the composite building material 14 so as to form a load-bearing structure 15 comprising a main wall 16 provided with a first face facing the thermal insulation elements 7 and a second face opposite the first face, the load-bearing structure 15 further comprising longitudinal 17 and transverse 18 edges formed by the hardening of the composite building material 14 poured into each of the longitudinal and transverse recesses 11A and 11B, the thermal insulation elements 7 being secured and made inseparable from the load-bearing structure 15 during the hardening of the composite building material 14,
removing the main formwork 2 surrounding the prefabricated element 1 thus obtained; and
removing the inserts to be demolded in order to define a shoulder area 24.

Advantageously, the spacing distance between two adjacent fastening inserts 23 is defined so as to correspond to the spacing between two finishing plates, such as plasterboards for example, the finishing plates being affixed to the inner face of the prefabricated element 1 in order to carry out the finishing and the cladding of the dwelling unit. Advantageously, each fastening insert 23 makes it possible to easily secure finishing plates to the inner face of the prefabricated element 1 by means of plasterboard screws for example.

As can be seen more particularly in FIGS. 8 and 9, the prefabricated element 1 obtained by the manufacturing method according to the second embodiment of the invention includes longitudinal and transverse edges 17 and 18 which have a thickness less than the maximum thickness of the adjacent thermal insulation element 7, such that each thermal insulation element 7 projects relative to the longitudinal 17 and transverse 18 edges. The longitudinal 17 and transverse 18 edges and the thermal insulation elements 7 delimit a shoulder area 24 extending around the periphery of the load-bearing structure and making it possible to form, when assembling two adjacent prefabricated elements, a junction which does not reveal the load-bearing structures 14 of said prefabricated elements 1 from the inside of the dwelling unit.

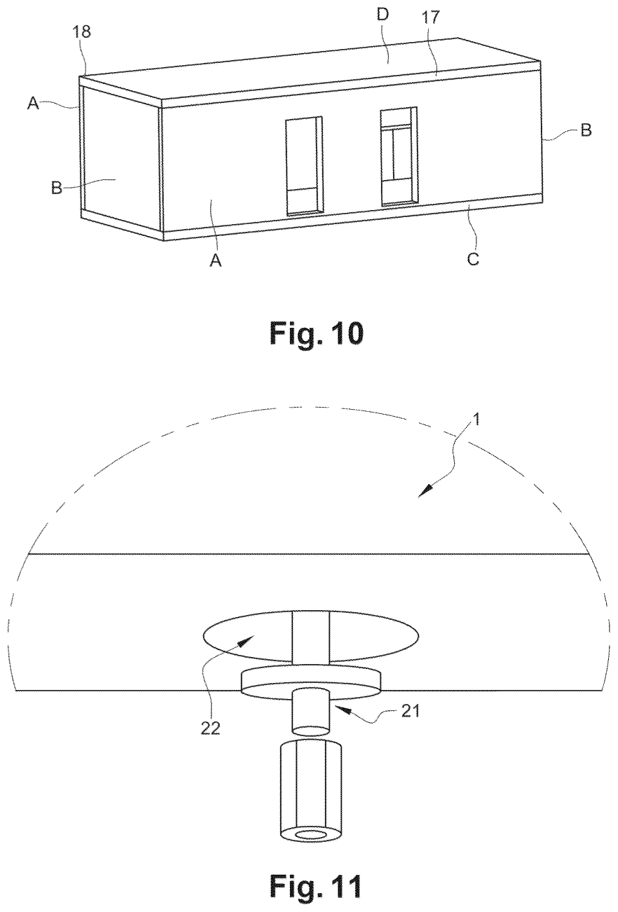

The dwelling unit, an exemplary embodiment of which is presented in FIG. 10, includes two longitudinal elements A, two lateral elements B, a low floor C and a high floor D each consisting of a prefabricated element 1 originating from the implementation of the manufacturing method according to the invention.

Of course, the present invention is in no way limited to the embodiments described and illustrated which have been given only as examples. The reversal of at least one panel of the dwelling unit or modifications remain possible, in particular from the point of view of the constitution of the various elements or by substitution of technical equivalents, without departing from the scope of protection of the invention.

1. A method for manufacturing a prefabricated element for a dwelling unit, the manufacturing method including the following steps:
providing a main formwork comprising a bottom wall and a peripheral frame, the bottom wall and the peripheral frame delimiting an internal space,
placing at least one thermal insulation element, such as a thermal insulation panel for example, in the internal space of the main formwork such that the at least one thermal insulation element rests on the bottom wall, the at least one thermal insulation element and the main formwork being configured so as to delimit at least in part a longitudinal recess extending along each internal longitudinal face of the main formwork, and at least in part a transverse recess extending along each internal transverse face of the main formwork,
pouring a composite building material, which is hardenable, inside the internal space of the main formwork so as to at least partially cover the at least one thermal insulation element and to at least partially fill each of the longitudinal and transverse recesses,
hardening the composite building material so as to form a load-bearing structure comprising a main wall provided with a first face facing the at least one thermal insulation element and a second face opposite the first face, the load-bearing structure further comprising two longitudinal edges extending respectively along two opposite longitudinal edges of the main wall and projecting from the first face of the main wall and two transverse edges extending respectively along two opposite transverse edges of the main wall and projecting from the first face of the main wall, the longitudinal and transverse edges also being formed by the hardening of the composite building material poured into each of the longitudinal and transverse recesses, the at least one thermal insulation element being secured and made inseparable from the load-bearing structure during the hardening of the composite building material,
removing the main formwork surrounding the prefabricated element thus obtained,
wherein the thermal insulation element includes a main area which is quadrangular in shape, at least one of the upper ridges of the main area being rounded or including a cutaway.

2. The manufacturing method according to claim 1, wherein the thermal insulation element further includes a thinned peripheral area which is contiguous to the main area and which extends at least partly around the main area, the thinned peripheral area being configured to form at least partly at least one of the longitudinal and transverse recesses.

3. The manufacturing method according to claim 1, wherein the composite building material is made from crushed materials, natural materials, or a combination of crushed and natural materials, which are agglomerated by a binder.

4. The manufacturing method according to claim 1, wherein the at least one thermal insulation element also includes at least one longitudinal groove which is configured to be filled by the composite building material during the pouring step and/or at least one transverse groove which is configured to be filled by the composite building material during the pouring step, such that the load-bearing structure includes at least one longitudinal reinforcing rib and/or at least one transverse reinforcing rib.

5. The manufacturing method according to claim 1, wherein the placing step includes placing several thermal insulation elements in the internal space of the main formwork, two adjacent thermal insulation elements being configured to delimit an intermediate recess configured to be filled by the composite building material during the pouring step such that the load-bearing structure includes at least one intermediate reinforcing rib located between two adjacent thermal insulation elements.

6. The manufacturing method according to claim 1, which further includes the following step, which is prior to the pouring step:
placing at least one fastening insert, such as a wooden batten for example, in the internal space of the main formwork such that the at least one fastening insert rests on the bottom wall and is disposed between and in contact with two adjacent thermal insulation elements, the at least one fastening insert being secured and made inseparable from the load-bearing structure during the hardening of the composite building material and being configured to receive inner cladding supports.

7. The manufacturing method according to claim 1, which further includes the following step, which is prior to the pouring step:
placing at least one insert to be demolded in the internal space of the main formwork such that the at least one insert to be demolded rests on the bottom wall and is adjoined to one of the sides of the peripheral frame.

8. The manufacturing method according to claim 7, which further includes the following step, subsequent to the hardening step:
removing at least one insert to be demolded in order to define a shoulder area.

9. The manufacturing method according to claim 1, which also includes the following step, prior to the step of placing the at least one thermal insulation element:
placing at least one secondary formwork, provided with an internal frame, in the internal space of the main formwork such that the internal frame rests on the bottom wall;
and wherein the at least one thermal insulation element and/or the at least one secondary formwork are configured so as to delimit a secondary recess extending around the secondary formwork and intended to be filled, at least in part, with the composite building material during the pouring step.

10. The manufacturing method according to claim 1, wherein two opposite longitudinal or transverse edges of the load-bearing structure respectively include first and second assembly elements configured to allow the assembly of two prefabricated elements adjacent to each other.
